(19) United States
(12) Patent Application Publication
(10) Pub. No.: US 2002/0166606 A1
(43) Pub. Date: Nov. 14, 2002

(54) Method of coating a metal substrate

(76) Inventor: Russell Caminiti, Mansfield, MA (US)

Correspondence Address: BRIAN J. EASTLEY, 24 BIRD ROAD, MANSFIELD, MA, 02048, US

(21) Appl. No.: 09/802,724

(22) Filed: Mar. 12, 2001

(51) Int. Cl. B32B 9/00

(52) U.S. Cl. 148/212; 428/698; 428/469; 428/336; 148/284

(57) ABSTRACT

A method of coating a metal substrate, the method comprising the steps of forming the metal substrate, nitriding the substrate to form an oxide layer, and subsequently applying a metal compound coating comprising a titanium, zirconium, or aluminum compound using a vacuum chamber process such as physical vapor deposition (PVD) or chemical vapor deposition (CVD). Optionally, the process may include additional coating steps and/or a heat treatment step following the coating step(s). A polytetrafluoroethylene coating may also be added after the metal compound coating(s) and before any final heat treating.

A coated metal substrate resulting from this process is also disclosed, wherein the metal substrate contains one or more metal compound layers of titanium, zirconium, or aluminum compounds, over a nitrided surface of the metal substrate.

### BACKGROUND OF THE INVENTION

The twist drill was invented in the late 1850's by a group of mechanics working for Providence Tool Co. in Providence, R.I. In 1863, Stephen A. Morse of East Bridgewater, Mass. received U.S. Pat. No. 38,119, for a carbon steel twist drill with helical angle flutes to discharge the chips and borings without clogging. He introduced it at the Philadelphia Centennial Exhibition in 1877, and for the next eighty years the standard in the industry was his 118° point carbon steel drill bit.

A high-speed steel bit, containing Molybdenum and referred to as M-50 steel, was also developed, but was considered a high-end bit for maintenance people and was seldom used.

Today the only carbon steel bits are generally imported and manufactured for discount stores; and the M-50 high speed steel bit is a standard item in hardware and retail stores. Three other commonly available drill bit types are referred to as M2, M7, and M42 (Cobalt steel).

Cobalt steel is used for the harder, tougher alloy steels of the stainless and manganese types, as well as castings, forgings, and chilled cast iron. Cobalt drill bits can be run approximately 25% faster than those of high-speed steel, because of Cobalt steel's ability to withstand high cutting temperatures due to its high red hardness, corresponding to a Rockwell C hardness of 64-67.

The drill bit of choice for the last 10-15 years has been a Hi-Molybdenum tool steel (M-2, M-7, and M-42) that has been nitrided to form a hard oxide surface layer. This makes the drill bit surface harder than Cobalt steel but maintains the flexibility of quality tool steel. These types of bits have been sold almost exclusively through specialty suppliers.

Commonly-Used Tool Steels are Listed in the Table Below.

| | |
|---|---|
| Tool Steels | A-2, D-2, M2 |
| Hot Work Steels | H-10, H13 |
| PH Steels | 17-4, 17-7, 15-5, 13-8 |
| High Speed Steels | Molybdenum & Tungsten |
| Stainless Steels | 300 & 400 Series |
| Alloys Steels | 4000 & 8000 |
| PM Alloys | Nitralloy & Cast Iron |
| Tungsten Carbide | WC |

Standard Manufacture of Drill Bits

A standard drill bit manufacturing process, such as that used by Viking Drill & Tool, Inc., is comprised of the following steps.

1. Raw steel cut off

2. Soft metal removal

3. Heat treatment via three salt solutions: (preheat, high heat; & quench bath), air cool.

4. Hardness testing.

5. Centerless Grinding

6. Flute Grinding

7. Clearance Grinding

8. Pointing: e.g., 118° general purpose point and 135° split point for heavy-duty drills.

However, today's Space Age alloys used in manufacturing parts are more complex, harder, lighter and more heat resistant than even just a few years ago-even harder than the current drill bit material.

Alloys have changed to harder, lighter materials tQ provide higher energy efficiency, for example, in vehicles. Consequently, a proliferation of alloys and tool steels has occurred:

More aluminum and aluminum alloys

More heat treated tool steels

More vanadium and tungsten added to tool steels

More Resins with higher hardness

More stainless steel

More composite materials

More titanium materials

As a result, when attempting to drill a new Diesel manifolds or some of the new wheel bearings, common drill bits experience heat-hardening, which results in increased brittleness and shorter lifetimes. Standard M-50 and M-1 or M-2 have difficulty even penetrating, and when they do, their life expectancy is very short, leading to frequent downtime and changeovers, with associated high costs of direct labor and manufacturing.

To improve the cutting performance of an M-50 tool bit, it is also common in the industry to apply of coating of titanium nitride (TiN), but since the underlying M-50 material is fairly soft, the increased performance of the TiN coating is marginal and short-lived. For example, the Vermont Tap & Die Company teaches a process for coating a standard, high-speed (M-50) tool steel with a titanium nitride (TiN) coating by a physical vapor deposition (PVD) technique. The PVD is a high vacuum process in which the titanium is vaporized and reacted with nitrogen to form a compound layer on the surface of the high speed steel taps and drills. The titanium nitride coating is a refractory compound with a hardness of 80 Rockwell C. Tests performed by the Vermont Tap & Die Company show that TiN coated drills outperform standard (M-50) uncoated ¼″ drills in 4340 steel (32 Rc) at 93 ft/min at 1415 rpm, 0.0045 in/rev. Titanium metal (e.g., TiN) coated steel is referenced widely in the industry and is designed for machine shops, where speeds and feeds were known, and materials being drilled were constant. However, even these drill bits experience extremely short lifetimes. Titanium metal (TiN) coatings are applied via physical-vapor deposition (PVD) and chemical-vapor deposition (CVD) processes to bright metal substrates, but these coatings wear off quickly, providing only marginal increase in performance.

A standard PVD or CVD process includes the steps of:

(a) Placing a substrate to be coated in a chamber containing a metal compound (e.g., titanium compound) as a target and a nitrogen-containing compound (e.g., N2, NH3, or amines) and a carbon-containing compound (e.g., gaseous hydrocarbons).

(b) Creating a physical vapor from the corresponding metal compound target to react with the nitrogen- or carbon-containing compound to form a refractory layer on the substrate.

More specifically, a common CVD coating method is taught in U.S. Pat. No. 5,693,408, and is carried out by precipitating a surface layer onto a substrate from a reactive gas atmosphere, which generally has a temperature between 900° C. and 1200° C. The gas atmosphere contains several compounds, which react with one another at the reaction temperature and form the material in the surface layer. It is standard to coat metallic substrates with hard-material layers of carbides, nitrides, or carbonitrides with the overall atmosphere containing halogenides of the elements from the group III to VI of the periodic table and including a nitrogen-containing compound and a carbon-containing compound. Thus a titanium-carbide layer is coated onto a hard-metal base body at about 1000° C. from a gas atmosphere, which contains titanium tetrachloride and methane. As the carbon compounds, gaseous hydrocarbons are used while N2, NH3 or amines are used as the nitrogen-containing compounds.

By comparison physical-vapor deposition (PVD) processes use temperatures in the range of 500-600° C.

To summarize, bright metal substrates can be coated with a metal compound coatings; e.g., TiN, to improve surface hardness, but lifetimes are limited by the relative softness of the underlying metal. While it was also known to harden the surface of the metal substrates by a nitriding process to form an oxide layer, the resulting oxide layer could not be subsequently coated with titanium or zirconium compounds.

### DISCUSSION OF PRIOR ART

U.S. Pat. No. 4,337,300 to Itaba et al. discloses a surface-coated blade member for cutting tools and the process for producing the blade member. More specifically, the product is described as a metal substrate and a first coating of vapor deposited titanium, with a second layer of vapor deposited titanium compound, selected from the group consisting of titanium carbide, titanium metal, titanium carbonitride, titanium oxy-carbide and titanium oxy-carbo-nitride, said titanium layer being no more than 2 um thick, and said titanium compound being 0.5 um to 10 um thick. Itaba et al. teach using a vacuum temperature of preferably 600° C., and NOT below 300° C. Itaba also teaches that the layer of titanium and the layer of titanium compound are successively formed by vapor deposition in a single vacuum chamber, and that the first layer of vapor deposited titanium should not be exposed to the atmosphere since the oxides of titanium would form on this first layer and that this would adversely affect the strength of bonding between the layer of titanium and the subsequently vapor deposited layer of titanium compound. Itaba et al. do not disclose any post-coating heat-treatment step.

Itaba (U.S. Pat. No. 4,450,205) teaches surface-coating a blade member for cutting tools comprising a metal substrate of a super hard alloy (e.g., carbide) and a coating on at least one surface, said coating being composed of a layer of vapor deposited titanium (</=2 um thick) plus a layer of a titanium compound (TiC, TiN, TiCN, etc.) 0.5-10 um thick. Again, no initial nitriding step or post-coating heat-treatment step is disclosed. Sue, et al. (U.S. Pat. No. 5,071,693) disclose a multilayer coating of a nitride-containing compound and method for producing it.

A multiplayer coating of at least 2 layers of a nitride-containing compound, such as titanium nitride, in which at least one layer contains at least 2 atomic percent of nitrogen different than the nitrogen contained in an adjacent layer. Also discloses process for producing the multilayer coating. Beginning and ending hardening steps are not disclosed.

Ito et al. (U.S. Pat. No. 5,192,410) teach a process for manufacturing multi-ceramic layer-coated metal plate.

Colored ceramic layer made of at least one selected from the group consisting of nitrides and carbides of titanium, zirconium, hafnium, chromium, niobium, and aluminum and having a thickness of 0.1 um to 1 um.

Kawamura et al. (U.S. Pat. No. 5,260,107) teach a plasma chemical vapor deposition process for producing a hard (e.g., carbide) multilayer coated product. A hard multi-layer coated product comprising a hard wear-resistant titanium compound coating layer, a titanium compound layer having a compositional gradient and a self lubricating coating layer comprising hard amorphous carbon as the principal component successively formed on the surface of a substrate, the first layer being formed at about 500° C. by the plasma CVD method in a vacuum followed by the formation of the second and third layers at 250° to 400° C. in a vacuum maintained at the same level as above. The hard multilayer coated product is improved in wear-resistance and self-lubricity.

Nieh et al. (U.S. Pat. No. 5,487,922) teach a surface preparation and deposition method for titanium nitride onto carbon-containing materials. Wear-resistant titanium nitride coatings onto case iron and other carbon-containing materials is enhanced by means of a new surface preparation and deposition process.

H. Curtins, “PLATIT: a new industrial approach to cathodic arc coating technology,” Surface and Coatings Technology 76-77 (1995) pp. 632-639.

The patent to Kikuchi et al. (U.S. Pat. No. 4,463,033) discloses a multiplayer coating comprising an inner layer of titanium oxycarbide (CVD), and a layer of aluminum oxide.

The patent to Keem et al. (U.S. Pat. No. 4,724,169) discloses the use of multiplayer coatings wherein the layers include compounds of titanium and/or zirconium. Keem also discloses the use of a lubricating layer comprising TFE and FEB resins and Polytetrafluoroethylene). Nevertheless, there are very few details, which specifically describe the manner in which the layers are deposited, and for the most part the application focuses on multiple unit layers, each unit comprising three distinct layers. Keem et al. do not teach any post heating steps to meld the layers together.

### BRIEF SUMMARY OF THE INVENTION

It is therefore an objective of this invention to disclose a process for applying a hard metal coating over an oxide layer of a nitrided metal substrate, using a PVD or CVD process.

First, a precision-metal substrate, for example, a drill bit, is made from one of the conventional steels well known in the art. The metal substrate may comprise a cutting tool such as a drill bit, but may also include a flexible cutting tool; e.g., a band saw blade.

Next, the metal substrate is placed in a vessel, where the substrate is ion-nitrided, salt-nitrided and/or carbo-nitrided for a time of 15 minutes to 48 hours, at temperatures in the range of 90° C. -650° C., resulting in a hard oxide layer over the substrate.

As described in the prior art, this nitrided substrate normally constituted the finished product; no additional coating processes were conducted because subsequent coatings would not adhere to the oxide layer. The prior art teaches applying a hard metal coating to a “bright” metal substrate; i.e., a metal substrate, which has not undergone a nitriding step to produce an oxide layer.

The key hard metal compounds are comprised of titanium, zirconium, and/or aluminum (e.g., TiN, TiCN, TiAIN, AlTiN), and are representative of standard materials used in CVD and PVD vacuum chambers for coating substrates. “Zirconium” is a natural element, but is also used in this application to represent another family of hard metal compounds, such as ZrN, ZrCN, ZrAIN, ZrTiN, ZrAITiN.

Zirconium Simatace® is an ultra-fine crystalline alloy coating based on the rare Zirconium metal compound and the Titanium Alloy which includes Tungsten, Chrome, and Cobalt, using Nitrogen to turn the chamber into a plasma chamber, which coating results in a harder, denser, drill bit coating that still flexes, but outperforms and outlasts standard drill bits by up to a factor of 15. The tool steel is not annealed in order to maintain the hardness. An embodiment of the present invention teaches applying a Zirconium alloy coating to the nitrided substrate having an oxide layer, using a particle vapor deposition or CVD process with a Zirconium metal compound.

Optionally, subsequent coating(s) may be applied and/or heat treatment steps may be performed.

The alloy coating is so hard that it exceeds 92 Rockwell C Hardness, compared to 80 Rockwell C for the titanium-coated bits over non-carbo-nitrided steel.

The article resulting from this process will perform with great strength and flexibility, notwithstanding variations in materials, such as those materials described earlier in this disclosure.

### DETAILED DESCRIPTION OF THE INVENTION

The process for coating a cutting surface is comprised of the following steps.

Provide a metal substrate, made from conventional steels; i.e., carbide steels, carbon-based steels and its alloys, cast iron, and non-ferrous steels. More specifically, these conventional steels comprise Tool Steel (A-2, D-2, M2); Hot Work steel (H-10, H-13); PH Steel (17-4, 17-7, 15-5, 13-8); High Speed Steel (Molybdenum & Tungsten); Stainless Steel (300 & 400 Series); Alloy Steel (4000 & 8000); PM Alloys (Nitralloy & Cast Iron), or carbide steels (WC group).

The metal substrate, a drill bit for example, is initially formed per standard procedures well known in the industry, such as that described in the Viking Drill & Tool Catalog Introduction.

1. Tool steel is cut to length to form blanks.

2. The blanks are turned, necked, and market using a lathe.

3. The blanks are then heat treated: first preheated, then to a high heat treatment, next to a quench bath for rapid partial cooling, and finally to an air cool step to complete the hardening process. Heat treat salt residue is removed via a wash process after cooling. Blanks at this stage are very brittle and must be tempered twice to relieve the heat treat stress. This tempering imparts toughness to the blanks so they are better able to withstand shock and side thrust forces.

4. The drill blanks are centerless ground to establish the roundness, back taper and finished diameter.

5. Most twist drills have two flutes or grooves set in a spiral from point to shank

6. The drill bits are then pointed, the most common point being the 1180 general purpose point which is used in machine and hand drilling operations on a very side variety of materials. 1350 split points are almost always used on heavy-duty drills.

The cutting tool is then hardened using a coating process of either:

Plasma nitriding or ion nitriding or salt nitriding at a temperature in the range of 100° C. -650° C. for 15 minutes to 48 hours. This step hardens the steel by introducing carbon, nitrogen, and argon into the steel, resulting in an oxide layer.

Next, a hard metal coating of Titanium, Zirconium, or Aluminum metal compound is applied to the oxide layer of the hardened substrate, the compounds comprising TiN, TiCN, AlTiN, TiAIN, ZrN, ZrCN, AlZrN, or ZrAIN, using a PVD or CVD process with a target corresponding to one of the Titanium, Zirconium, or Aluminum metal compounds, at a temperature in the range of 288° C. to 5₉₃° C., to a thickness of 0.001 microns to 10.5 microns.

The hard metal coating will bond to the hardened oxide layer over the tool steel because both the hardening process and the coating processes are completed at lower temperatures than typically used in the industry. Note that the prior art teaches using a high heat process, whereas the step taught here would be considered a cold process, which results in less deformation of the substrate and therefore slower breakdown of the atoms in the coating and the substrate. Zirconium also adds lubricity, as one of it characteristic properties. This comprises the fundamental invention.

Optionally, the coated tool may be heat treated in a “cold process”, at a temperature of 120° C. to 366° C. The tool is gradually air quenched in a series of steps to reduce brittleness. This “cold” heat treating step melds the coatings together into a single coating without affecting the base steel hardness.

This heat treatment step is not disclosed in the prior art, furthermore, it was thought to be an unnecessary step, adding no additional value. Furthermore, Itaba teaches that a heat treatment step should not be performed to avoid too much diffusion of one metal layer into the substrate, thereby losing the desired properties of the coating.

Another embodiment of the invention includes the an additional step of applying a second coating of titanium, zirconium, or aluminum metal compound over the first metal compound coating, using a particle vapor deposition or CVD process with a corresponding metal compound target, at a temperature in the range of 288° C.—593° C., to a thickness of 0.001 um to 16.5 um. Optionally, a heat treating process is used after applying the second coating of metal compound.

The disclosed process can also include an optional step of applying a polytetrafluoroethylene coating over the titanium coating in the instance where there is only one metal compound coating, or over the second metal compound coating. This polytetrafluoroethylene coating would be used on cutting tools, such as saw blades and other cutting tools having wide surfaces that cause friction during cutting. However, the polytetrafluoroethylene coating is not used on cutting tools such as drill bits.

Specifically, different grades of polytetrafluoroethylene can be selected to provide different thickness and colors corresponding to associated properties (e.g., durability, lubricity, coarseness, color, heat-resistance, ductility).

An optional step of heat treating may be applied after the step of applying the polytetrafluoroethylene coating.

### EXAMPLE

A tungsten carbide (WC) drill bit was manufactured and then ion nitrided to form a hard oxide layer.

Subsequently, the oxide layer was coated with Zirconium Simatace®, a zirconium metal compound (ZrN), using a physical vapor deposition (PVD) process at 400° C., after which the coated tool was heat treated at 260° C. to form a bonded product with a Rockwell C hardness above 92.

The tool bit formed by the stated process was then tested, using as a reference the basic tungsten carbide tool bit without any additional treatments.

The non-coated tungsten carbide bits were used to bore holes in floorboards; the typical life of a non-coated bit was approximately 9 days before change-out and sharpening. The testing of the Zirconium Simatace® coated bits, has demonstrated that the bits could be run for 48 days without change out. Comparison between the highest used bits show that the non-coated carbide bit bored 7,233 holes in a nine-day period, in various types of materials. A similar 0.455″ bit with the Zirconium Simatacee coating applied bored 31,395 holes, in various types of materials. Similar results were seen in the 0.503″ and 0.6875″ bits that are used. See Table 1 for additional comparisons.

TABLE 1
Number of Holes Bored in different materials

| | |
|---|---|
| 0.455″ bit | 0.503″ bit |

| Material | | Zirconium | | Zirconium |
|---|---|---|---|---|
| Composition | Carbide | Simatace ® | Carbide | Simatace ® |
| .400 Paper | 3250 | 9467 | 300 | 773 |
| .400 Aluminum | 3662 | 20177 | — | 1399 |
| .665 Paper | 321 | 1639 | — | — |

I claim:

1. A Process for coating a metal substrate, comprising the steps of:
(a) providing a metal substrate, made from a conventional steel, said conventional steel comprising carbide steels, carbon-based steels and its alloys, cast iron, and non-ferrous steels;
(b) forming the metal substrate into a desired configuration;
(c) hardening the metal substrate through a process of either plasma nitriding, ion nitriding, or salt nitriding, at a temperature in the range of 93° C. to 650° C., for a time in the range of 15 minutes to 48 hours, to produce an oxide layer having a hardness greater than 67 on the Rockwell C scale; and,
(d) applying to said oxide layer a metal compound, said compound containing titanium, zirconium, and/or aluminum, comprising TiN, TiCN, AlTiN, TiAIN, ZrN, ZrCN, AlZrCN, or AlZrTiN, using a vacuum chamber process with a target corresponding to the titanium, zirconium, and/or aluminum compounds, at a temperature in the range of 288° C. to 5₉₃° C., to form a titanium, zirconium, or aluminum compound layer having a thickness of 0.001 microns to 10.5 microns, said compound layer having a hardness greater than 88 on the Rockwell C scale.

2. The process as in claim 1, wherein said vacuum chamber process is a physical vapor deposition (PVD) or a chemical vapor deposition (CVD) process.

3. The process as in claim 1, wherein said vacuum chamber process is a physical vapor deposition (PVD) process.

4. The process as in claims 1, 2, or 3, wherein said vacuum chamber process is conducted at a temperature of greater than 288° C. and less than 500° C.

5. The process as in claims 1, 2, 3, or 4, wherein said titanium, zirconium, or aluminum compound layer is applied to a thickness of 0.001 microns to 0.49 microns.

6. A surface coated substrate comprised of:
a metal substrate made from a conventional steel, said conventional steel comprising carbide steels, carbon-based steels and its alloys, cast iron, or non-ferrous steels;
an oxide layer formed by a process of either plasma nitriding, ion nitriding, or salt nitriding, at a temperature in the range of 93° C. to 650° C., for a time in the range of 15 minutes to 48 hours, to produce an oxide layer having a hardness greater than 67 on the Rockwell C scale; and,
a metal compound layer over said oxide layer, said compound layer comprising a titanium, zirconium, or aluminum compound, comprising TiN, TiCN, AlTiN, TiAIN, ZrN, ZrCN, AlZrCN, or AlZrTiN, using a vacuum chamber process with a target corresponding to one of the titanium, zirconium, or aluminum compounds, at a temperature in the range of 288° C. to 5₉₃° C., to form a titanium, zirconium, or aluminum compound layer having a thickness of 0.001 microns to 10.5 microns, said compound layer having a hardness greater than 88 on the Rockwell C scale.

7. The surface coated substrate as in claim 6, wherein said titanium, zirconium, or aluminum compound layer has a thickness of 0.001 microns to 0.49 microns.
